(19) United States
(12) Patent Application Publication
(10) Pub. No.: US 2013/0171291 A1
(43) Pub. Date: Jul. 4, 2013

(54) REGIONAL SUET COMPOSITIONS

(71) Applicant: SMG Brands, Inc., Wilmington, DE (US)

(72) Inventors: Gretchen Lynn WHITE, Marysville, OH (US); Tony Dale KEMP, Francesville, OH (US)

(73) Assignee: SMG BRANDS, INC., Wilmington, DE (US)

(21) Appl. No.: 13/730,238

(22) Filed: Dec. 28, 2012

Related U.S. Application Data
(60) Provisional application No. 61/582,006, filed on Dec. 30, 2011.

(51) Int. Cl. A23K 1/18

(52) U.S. Cl. CPC A23K 1/182
USPC 426/1

(57) ABSTRACT

Suet compositions intrinsically attractive to desirable birds in a particular region (e.g., northeast, southeast, midwest, southwest, and west) and which attract more desirable birds than other suet compositions. The suet compositions comprise tallow, peanuts, and corn in combination with black oil sunflower seeds, sunflower chips, white millet, and almonds; black oil sunflower seeds, sunflower chips, white millet, and pumpkin seeds; black oil sunflower seeds, sunflower chips, white millet, and safflower; dough mix and red millet, or dough mix and pecans.

### BACKGROUND OF THE INVENTION

1. Field of the Invention

The invention relates to suet compositions, and methods thereof, for attracting and feeding desirable birds in a particular region of the United States (e.g., northeast, southeast, midwest, southwest, and west).

2. Description of the Related Art

Bird watching enthusiasts have long sought to attract desirable birds for observation and enjoyment. A variety of methods and systems have been employed to attract greater numbers of desirable birds including suet compositions.

### Bird Food Mixtures

Bird food mixtures usually comprise varying amounts of different food items typically consumed by birds such as seeds, nuts, fruits, and suet. Typical bird food mixtures comprise 95% grain products by weight (e.g., corn and milo), plus black oil sunflower, and white millet. Many variations of this typical food mixture exist, as exemplified by Wagner's® Four Season Wild Bird Food which comprises milo, white millet, cracked corn, and black oil sunflower seed and GRREAT CHOICE® Wild Bird Seed Mix which comprises milo, white millet, and black oil sunflower seeds.

Some bird food mixtures are designed to be attractive to a given species of bird. For example, U.S. Patent Application Publication Nos. 2009/0304853 and 2009/0304900 disclose a mixture comprising thistle, red millet, and sunflower chips intrinsically attractive to desirable birds such as finches. See, also, Wagner's Cardinal Blend and Wagner's Finches Supreme. Other bird food mixtures are marketed as formulated to attract a given category of birds such as songbirds. See, e.g., Wagner's Orange Raisin-Nut Premium Songbird Blend.

Other bird food mixtures are labeled as blended for a given region. KAYTEE® Western, Southern, Northeast, and Midwest Regional Blends all appear to comprise sunflower hearts and chips, red millet, oil sunflower, safflower, and white millet. See KAYTEE® website. Additionally, Wagner's Regional Bird Food appear to comprise 25% black oil sunflower and striped sunflower seed plus safflower seeds. See Wagner's website.

Bird food mixtures that are intrinsically attractive to desirable birds in a particular region of the United States (e.g., northeast, southeast, midwest, southwest, and west) as well as methods for attracting desirable birds in a particular region of the United States are described in U.S. patent application Ser. No. 13/250,433.

### Suet

A cake of hard fat from around the kidneys of cattle and sheep mixed with seeds, grains, nuts and fruit used as food for wild birds such as woodpeckers, goldfinches, juncos, cardinals, thrushes, jays, kinglets, bluebirds, chickadees, nuthatches, wrens, and starlings. Suet may be made by rendering fat, adding ingredients, and then pouring into a mold allowing it to cool. Common traditional suet compositions comprises suet, rolled oats, cornmeal, peanut butter, wild bird seed, and sunflower seeds; suet, peanut butter, and cornmeal; or suet, crumbs, nuts, apples, raisins, sugar (sucrose), cornmeal, wheat flour, peanut butter, and wild bird seed. See attractwildbirds.com.

Several suet are available on the market including Wagner's® Seed 'n Suet High Energy Wild Bird Food comprising white proso millet, black oil sunflower, rendered beef suet, grain products, oats, and berry flavoring. Further, KAYTEE® Positively Peanut Suet comprises rendered beef suet, roasted peanuts, corn, oats, and peanut flavoring, KAYTEE® Suet & Seed comprises rendered beef suet, white millet, corn, and black oil sunflower, KAYTEE® Wild Berry Suet comprises rendered beef suet, white millet, corn, and berry flavoring, KAYTEE® Cherry Harvest Suet comprises rendered beef suet, white millet, corn, and cherry flavoring, KAYTEE® Orange Harvest Suet Dough comprises rendered beef suet, peanuts, papaya, corn, oats, and orange flavoring, and KAYTEE® Nutty Suet comprises rendered beef suet, roasted peanuts, millet, and corn. See KAYTEE® website. EP 0 766 923 describes a wild bird food comprising a mixture of fat and peanut flour. These commercially available suet compositions share similar ingredients and are described as generally attractive to birds.

Other suet compositions are designed to provide ample nutrition to birds regardless of the season, for example, Morning Song® Year-Round Suet comprises rendered beef suet, red milo, cracked corn, black oil sunflower, and white millet. Other suet compositions provide a high-energy food source with a particular flavoring, for example, Morning Song® Berry Punch Suet comprises rendered beef suet, white millet, cracked corn, red millet, and blueberry flavoring. See SCOTTS® website. Insects may also be included in suet for a high-protein food for birds, such as Insect Delight Suet Cake.

Some suet compositions designed to be attractive to individual birds are also available, such as SCOTTS® Songbird Selections® Multi-bird Suet which comprises rendered beef suet, black oil sunflower, white millet, cracked corn, wheat, safflower, striped sunflower, peanuts, and sunflower ships, and is designed to attract a wide variety of colorful, musical birds, and SCOTTS® Songbird Selections® Woodpecker Suet, which comprises rendered beef suet, black oil sunflower, peanuts, cracked corn, striped sunflower, peanut meal, raisin, pecans, and almonds, and is designed to attract a variety of woodpeckers. See SCOTTS® website.

While these various suet compositions and suet compositions may be attractive to desirable birds, there is still a need for a suet composition that is intrinsically attractive to desirable birds in a particular region of the United States, as well as methods for attracting desirable birds in a particular region of the United States.

### BRIEF SUMMARY OF THE INVENTION

In one aspect, the invention provides a composition that is intrinsically attractive to desirable birds. In another aspect, the invention provides a composition that increases the number of desirable birds available for viewing by bird enthusiasts without regard to the type of suet bird feeder mechanism used to dispense the food. In another embodiment, the invention provides a mixture that is intrinsically attractive to desirable birds in a given region of the United States (e.g., northeast, southeast, midwest, southwest, and west) available for observation. In a further embodiment, the invention provides a method for formulating, marketing, and selling a composition intrinsically attractive to desirable birds in a region of the United States (e.g., northeast, southeast, midwest, southwest, and west). These and other objects of the invention are met by one or more of the following embodiments.

A composition may comprises tallow, peanut meal, peanut pickouts (peanut pieces), cracked corn, and may further comprise: (a) black oil sunflower seeds and fine sunflower chips; (b) black oil sunflower seeds, fine sunflower chips, and white millet; (c) black oil sunflower seeds, fine sunflower chips, white millet, and almonds; (d) dough mix; (e) dough mix and red millet; (f) dough mix and pecans; (g) black oil sunflower seeds, fine sunflower chips, white millet, and safflower; or (h) black oil sunflower seeds, fine sunflower chips, white millet, and pumpkin seeds.

The invention also provides, for a system of suet compositions that may comprise at least two mixtures of (a)-(e):
(a) a first suet composition comprising tallow, peanut meal, peanut pickouts, cracked corn, black oil sunflower seeds, white millet, and almonds;
(b) a second suet composition comprising tallow, peanut meal, peanut pickouts, cracked corn, black oil sunflower seeds, white millet, and pumpkin seeds;
(c) a third suet composition comprising tallow, peanut meal, peanut pickouts, cracked corn, black oil sunflower seeds, white millet, and safflower;
(d) a fourth suet composition comprising tallow, peanut meal, peanut pickouts, cracked corn, dough mix, and pecans; and
(e) a fifth suet composition comprising tallow, peanut meal, peanut pickouts, cracked corn, dough mix, and red millet.

In one embodiment, the composition may comprise at least about 30%-60% tallow by weight. In another embodiment, the composition may comprise at least about 34%, 35%, 36%, 40%, or 42% tallow by weight.

In one embodiment, the composition may comprise at least about 1%-40% peanuts by weight. In another embodiment, the composition may comprise at least about 1%, 2%, 3%, 4%, 8%, 10%, 13%, 15%, 25%, or 30% peanuts by weight.

In one embodiment, the composition may comprise at least about 1%-40% peanut meal by weight. In another embodiment, the composition may comprise at least about 3%, 4%, 8%, 10%, 25%, or 30% peanut meal by weight.

In one embodiment, the composition may comprise at least about 1%-20% peanut pickouts (peanut pieces) by weight. In another embodiment, the composition may comprise at least about 1%, 2%, 3%, 10%, 13%, or 15% peanut pickouts (peanut pieces) by weight.

In one embodiment, the composition may comprise at least about 5%-15% cracked corn by weight. In another embodiment, the composition may comprise at least about 8%, 9%, 9.75%, 10%, 13%, or 14% cracked corn by weight.

In one embodiment, the composition may comprise at least about 2%-10% black oil sunflower seeds by weight. In another embodiment, the composition may comprise at least about 4%, 5%, 6%, 7%, or 8% black oil sunflower seeds by weight.

In one embodiment, the composition may comprise at least about 5%-15% sunflower chips (e.g., fine sunflower chips) by weight. In another embodiment, the composition may comprise at least about 5%, 7%, 8%, 10%, or 15% sunflower chips (e.g., fine sunflower chips) by weight.

In one embodiment, the composition may comprise at least about 1%-5% white millet by weight. In another embodiment, the composition may comprise at least about 1%, 1.5%, 1.75%, 2%, or 2.5% white millet by weight.

In one embodiment, the composition may comprise at least about 0.1%-5% almonds by weight. In another embodiment, the composition may comprise at least about 0.5%, 0.75%, 1%, 1.2%, or 2% almonds by weight.

In one embodiment, the composition may comprise at least about 1%-15% red millet by weight. In another embodiment, the composition may comprise at least about 4%, 5%, 6%, 7%, or 8% red millet by weight.

In one embodiment, the composition may comprise at least about 20%-50% dough mix by weight. In another embodiment, the composition may comprise at least about 25%, 35%, 37%, 38%, or 39% dough mix by weight. In another embodiment, the dough mix may comprise ground corn (e.g., cornmeal) and wheat middlings (wheat mill run). The dough mix may comprise at least about 90% ground corn by weight and at least about 10% wheat middlings. The dough mix may comprise flour and water.

In one embodiment, the composition may comprise at least about 1%-10% pecans by weight. In another embodiment, the composition may comprise at least about 1%, 2%, 3%, 3.5%, or 5% pecans by weight.

In one embodiment, the composition may comprise at least about 0.1%-5% pumpkin seeds by weight. In another embodiment, the composition may comprise at least about 0.5%, 0.75%, 1%, 1.25%, or 1.5% pumpkin seeds by weight.

In one embodiment, the composition may comprise at least about 0.1%-5% safflower by weight. In another embodiment, the composition may comprise at least about 0.5%, 0.75%, 1%, 1.25%, or 1.5% safflower by weight.

In one embodiment, the composition may further comprise at least about 0.01%-1% mineral oil by weight. In another embodiment, the composition may further comprise about 0.01%-0.06% mineral oil by weight. In another embodiment, the composition may further comprise at least about 0.02%, 0.04%, 0.05%, or 0.06% mineral oil by weight.

In one embodiment, the composition may comprise tallow, peanut meal, peanut pickouts, and cracked corn. In another embodiment, the composition may comprise at least about 30-45% tallow by weight, at least about 1-30% peanut meal by weight, at least about 1-15% peanut pickouts by weight, and at least about 8-15% crack corn by weight. In a further embodiment, the composition may comprise at least about 35% tallow by weight, at least about 25% peanut meal by weight, at least about 13% peanut pickouts by weight, and at least about 13% cracked corn by weight. In a further embodiment, the composition may comprise at least about 40% tallow by weight, at least about 8% peanut meal by weight, at least about 2% peanut pickouts by weight, and at least about 10% cracked corn by weight. In a further embodiment, the composition may comprise at least about 40% tallow by weight, at least about 4% peanut meal by weight, at least about 3% peanut pickouts by weight, and at least about 10% cracked corn by weight.

In another embodiment, the composition may comprise tallow, peanuts (e.g., peanut meal, peanut pickouts) and cracked corn. In another embodiment, the composition may comprise at least about 30-45% tallow by weight, at least about 1-30% peanuts (e.g., peanut meal, peanut pickouts) by weight, and at least about 8-15% crack corn by weight. In a further embodiment, the composition may comprise at least about 35% tallow by weight, at least about 28% peanuts by weight, and at least about 13% cracked corn by weight. In a further embodiment, the composition may comprise at least about 40% tallow by weight, at least about 10% peanuts by weight, and at least about 10% cracked corn by weight. In a further embodiment, the composition may comprise at least about 40% tallow by weight, at least about 7% peanuts by weight, and at least about 10% cracked corn by weight.

In one embodiment, the composition may comprise black oil sunflower seeds, sunflower chips (e.g., fine sunflower chips), and white millet. In another embodiment, the composition may comprise at least about 6% black oil sunflower seeds, at least about 5% sunflower chips (e.g., fine sunflower chips) by weight, and at least about 2% white millet by weight.

In one embodiment, the composition may comprise black oil sunflower seeds, sunflower chips (e.g., fine sunflower chips), white millet, and almonds. In another embodiment, the composition may comprise at least about 6% black oil sunflower seeds, at least about 5% sunflower chips (e.g., fine sunflower chips) by weight, at least about 2% white millet by weight, and at least about 1% almonds by weight.

In one embodiment, the composition may comprise red millet and dough mix. In another embodiment, the composition may comprise at least about 6% red millet and at least about 37% dough mix by weight.

In one embodiment, the composition may comprise pecans. In another embodiment, the composition may comprise at least about 3% pecans by weight.

In one embodiment, the composition may comprise pumpkin seeds. In another embodiment, the composition may comprise at least about 1% pumpkin seeds by weight.

In one embodiment, the composition may comprise safflower. In another embodiment, the composition may comprise at least about 1% safflower by weight.

In one embodiment, the composition may further comprise mineral oil by weight. In another embodiment, the composition may further comprise at least about 0.04% mineral oil by weight.

In one embodiment, the composition may comprise tallow, peanut meal, peanut pickouts, cracked corn, black oil sunflower seeds, sunflower chips, white millet, and almonds. In another embodiment, the composition may comprise at least about 35% tallow, 25% peanut meal, 13% peanut pickouts, 13% cracked corn, 6% black oil sunflower seeds, 5% sunflower chips (e.g., fine sunflower chips), 2% white millet, and 1% almonds by weight. In a further embodiment, the composition may further comprise at least about 0.04% mineral oil by weight.

In one embodiment, the composition may comprise tallow, peanut meal, peanut pickouts, cracked corn, black oil sunflower seeds, sunflower chips, white millet, and pumpkin seeds. In another embodiment, the composition may comprise at least about 35% tallow, 25% peanut meal, 13% peanut pickouts, 13% cracked corn, 6% black oil sunflower seeds, 5% sunflower chips (e.g., fine sunflower chips), 2% white millet, and 1% pumpkin seeds by weight. In a further embodiment, the composition may further comprise at least about 0.04% mineral oil by weight.

In one embodiment, the composition may comprise tallow, peanut meal, peanut pickouts, cracked corn, dough mix and pecans. In another embodiment, the composition may comprise at least about 40% tallow, 8% peanut meal, 2% peanut pickouts, 10% cracked corn, 37% dough mix, and 3% pecans by weight. In a further embodiment, the composition may further comprise at least about 0.04% mineral oil by weight.

In one embodiment, the composition may comprise tallow, peanut meal, peanut pickouts, cracked corn, dough mix, and red millet. In another embodiment, the composition may comprise at least about 40% tallow, 4% peanut meal, 3% peanut pickouts, 10% cracked corn, 37% dough mix, and 6% red millet by weight. In a further embodiment, the composition may further comprise at least about 0.04% mineral oil by weight.

In one embodiment, the composition may comprise tallow, peanut meal, peanut pickouts, cracked corn, black oil sunflower seeds, sunflower chips, white millet, and safflower. In another embodiment, the composition may comprise at least about 35% tallow, 25% peanut meal, 13% peanut pickouts, 13% cracked corn, 6% black oil sunflower seeds, 5% sunflower chips (e.g., fine sunflower chips), 2% white millet, and 1% safflower by weight. In a further embodiment, the composition may further comprise at least about 0.04% mineral oil by weight.

In one aspect, the invention provides a container, item, holder, bird feeder, or package comprising the composition described herein.

In another aspect, the invention provides a method of manufacturing a composition comprising combining tallow, peanut meal, peanut pickouts, cracked corn, and may further comprise: (a) black oil sunflower seeds and fine sunflower chips; (b) black oil sunflower seeds, fine sunflower chips, and white millet; (c) black oil sunflower seeds, fine sunflower chips, white millet, and almonds; (d) dough mix; (e) dough mix and red millet; (f) dough mix and pecans; (g) black oil sunflower seeds, fine sunflower chips, white millet, and safflower; or (h) black oil sunflower seeds, fine sunflower chips, white millet, and pumpkin seeds. In one embodiment, the method of manufacturing described herein further comprises adding mineral oil to said mixture.

In another aspect, the invention provides a method for attracting desirable birds comprising placing the composition described herein at a location where it is available to birds.

In a further aspect, the invention provides a method for increasing sales of a composition comprising combining said composition components to manufacture a composition, wherein said components are selected based on the food preferences or dietary needs of desirable birds in a given region, and identifying said mixture as suitable for birds of a specific region. In one embodiment, the method of increasing sales described herein further comprises labeling said composition as formulated for a region. In another embodiment, the method of increasing sales described herein further comprises bagging said composition. In another embodiment, the method of increasing sales described herein further comprises offering said composition for sale.

In a still further aspect, the invention provides a method of attracting desirable birds comprising combining composition components to manufacture a composition as described herein, wherein said components are selected based on the food preferences or dietary needs of desirable birds in a region, and making said mixture available to desirable birds.

In another embodiment, the invention provides a system of regional compositions comprising at least two mixtures of (a)-(e):
(a) a composition corresponding to a first region and comprising tallow, peanut meal, peanut pickouts, cracked corn, black oil sunflower seeds, sunflower chips, white millet, and almonds;
(b) a composition corresponding to a second region and comprising tallow, peanut meal, peanut pickouts, cracked corn, black oil sunflower seeds, sunflower chips, white millet, and pumpkin seeds;
(c) a composition corresponding to a third region and comprising tallow, peanut meal, peanut pickouts, cracked corn, dough mix and pecans;
(d) a composition corresponding to a fourth region and comprising tallow, peanut meal, peanut pickouts, cracked corn, dough mix, and red millet;
(e) a composition corresponding to a fifth region and comprising tallow, peanut meal, peanut pickouts, cracked corn, black oil sunflower seeds, sunflower chips, white millet, and safflower.

In one embodiment, the system described herein comprise raisins and white millet. In another embodiment, at least one of said compositions comprise safflower. In another embodiment, at least one of said compositions further comprise mineral oil. In another embodiment, at least one of said regions are the northeast, southeast, midwest, southwest, or western regions of the United States.

In one aspect, the invention provides a suet composition that is intrinsically attractive to desirable birds. In another aspect, the invention provides a suet composition that increases the number of desirable birds available for viewing by bird enthusiasts without regard to the type of suet bird feeder mechanism used to dispense the food. In another embodiment, the invention provides a mixture that is intrinsically attractive to desirable birds in a given region of the United States (e.g., northeast, southeast, midwest, southwest, and west) available for observation. In a further embodiment, the invention provides a method for formulating, marketing, and selling a suet composition intrinsically attractive to desirable birds in a region of the United States (e.g., northeast, southeast, midwest, southwest, and west). These and other objects of the invention are met by one or more of the following embodiments.

A suet composition may comprises tallow, peanut meal, peanut pickouts, cracked corn, and may further comprise: (a) black oil sunflower seeds and fine sunflower chips; (b) black oil sunflower seeds, fine sunflower chips, and white millet; (c) black oil sunflower seeds, fine sunflower chips, white millet, and almonds; (d) dough mix; (e) dough mix and red millet; (f) dough mix and pecans; (g) black oil sunflower seeds, fine sunflower chips, white millet, and safflower; or (h) black oil sunflower seeds, fine sunflower chips, white millet, and pumpkin seeds.

In one embodiment, the suet composition may comprise at least about 30%-60% tallow by weight. In another embodiment, the suet composition may comprise at least about 34%, 35%, 36%, 40%, or 42% tallow by weight.

In one embodiment, the suet composition may comprise at least about 1%-40% peanuts by weight. In another embodiment, the suet composition may comprise at least about 1%, 2%, 3%, 4%, 8%, 10%, 13%, 15%, 25%, or 30% peanuts by weight.

In one embodiment, the suet composition may comprise at least about 1%-40% peanut meal by weight. In another embodiment, the suet composition may comprise at least about 3%, 4%, 8%, 10%, 25%, or 30% peanut meal by weight.

In one embodiment, the suet composition may comprise at least about 1%-20% peanut pickouts by weight. In another embodiment, the suet composition may comprise at least about 1%, 2%, 3%, 10%, 13%, or 15% peanut pickouts by weight.

In one embodiment, the suet composition may comprise at least about 5%-15% cracked corn by weight. In another embodiment, the suet composition may comprise at least about 8%, 9%, 9.75%, 10%, 13%, or 14% cracked corn by weight.

In one embodiment, the suet composition may comprise at least about 2%-10% black oil sunflower seeds by weight. In another embodiment, the suet composition may comprise at least about 4%, 5%, 6%, 7%, or 8% black oil sunflower seeds by weight.

In one embodiment, the suet composition may comprise at least about 5%-15% sunflower chips (e.g., fine sunflower chips) by weight. In another embodiment, the suet composition may comprise at least about 5%, 7%, 8%, 10%, or 15% sunflower chips (e.g., fine sunflower chips) by weight.

In one embodiment, the suet composition may comprise at least about 1%-5% white millet by weight. In another embodiment, the suet composition may comprise at least about 1%, 1.5%, 1.75%, 2%, or 2.5% white millet by weight.

In one embodiment, the suet composition may comprise at least about 0.1%-5% almonds by weight. In another embodiment, the suet composition may comprise at least about 0.5%, 0.75%, 1%, 1.2%, or 2% almonds by weight.

In one embodiment, the suet composition may comprise at least about 1%-15% red millet by weight. In another embodiment, the suet composition may comprise at least about 4%, 5%, 6%, 7%, or 8% red millet by weight.

In one embodiment, the suet composition may comprise at least about 20%-50% dough mix by weight. In another embodiment, the suet composition may comprise at least about 25%, 35%, 37%, 38%, or 39% dough mix by weight.

In one embodiment, the suet composition may comprise at least about 1%-10% pecans by weight. In another embodiment, the suet composition may comprise at least about 1%, 2%, 3%, 3.5%, or 5% pecans by weight.

In one embodiment, the suet composition may comprise at least about 0.1%-5% pumpkin seeds by weight. In another embodiment, the suet composition may comprise at least about 0.5%, 0.75%, 1%, 1.25%, or 1.5% pumpkin seeds by weight.

In one embodiment, the suet composition may comprise at least about 0.1%-5% safflower by weight. In another embodiment, the suet composition may comprise at least about 0.5%, 0.75%, 1%, 1.25%, or 1.5% safflower by weight.

In one embodiment, the suet composition may further comprise at least about 0.01%-1% mineral oil by weight. In another embodiment, the suet composition may further comprise at least about 0.02%, 0.04%, 0.05%, or 0.06% mineral oil by weight.

In one embodiment, the suet composition may comprise tallow, peanut meal, peanut pickouts, and cracked corn. In another embodiment, the suet composition may comprise at least about 30-45% tallow by weight, at least about 1-30% peanut meal by weight, at least about 1-15% peanut pickouts by weight, and at least about 8-15% crack corn by weight. In a further embodiment, the suet composition may comprise at least about 35% tallow by weight, at least about 25% peanut meal by weight, at least about 13% peanut pickouts by weight, and at least about 13% cracked corn by weight. In a further embodiment, the suet composition may comprise at least about 40% tallow by weight, at least about 8% peanut meal by weight, at least about 2% peanut pickouts by weight, and at least about 10% cracked corn by weight. In a further embodiment, the suet composition may comprise at least about 40% tallow by weight, at least about 4% peanut meal by weight, at least about 3% peanut pickouts by weight, and at least about 10% cracked corn by weight.

In another embodiment, the suet composition may comprise tallow, peanuts (e.g., peanut meal, peanut pickouts) and cracked corn. In another embodiment, the suet composition may comprise at least about 30-45% tallow by weight, at least about 1-30% peanuts (e.g., peanut meal, peanut pickouts) by weight, and at least about 8-15% crack corn by weight. In a further embodiment, the suet composition may comprise at least about 35% tallow by weight, at least about 28% peanuts by weight, and at least about 13% cracked corn by weight. In a further embodiment, the suet composition may comprise at least about 40% tallow by weight, at least about 10% peanuts by weight, and at least about 10% cracked corn by weight. In a further embodiment, the suet composition may comprise at least about 40% tallow by weight, at least about 7% peanuts by weight, and at least about 10% cracked corn by weight.

In one embodiment, the suet composition may comprise black oil sunflower seeds, sunflower chips (e.g., fine sunflower chips), and white millet. In another embodiment, the suet composition may comprise at least about 6% black oil sunflower seeds, at least about 5% sunflower chips (e.g., fine sunflower chips) by weight, and at least about 2% white millet by weight.

In one embodiment, the suet composition may comprise black oil sunflower seeds, sunflower chips (e.g., fine sunflower chips), white millet, and almonds. In another embodiment, the suet composition may comprise at least about 6% black oil sunflower seeds, at least about 5% sunflower chips (e.g., fine sunflower chips) by weight, at least about 2% white millet by weight, and at least about 1% almonds by weight.

In one embodiment, the suet composition may comprise red millet and dough mix. In another embodiment, the suet composition may comprise at least about 6% red millet and at least about 37% dough mix by weight.

In one embodiment, the suet composition may comprise pecans. In another embodiment, the suet composition may comprise at least about 3% pecans by weight.

In one embodiment, the suet composition may comprise pumpkin seeds. In another embodiment, the suet composition may comprise at least about 1% pumpkin seeds by weight.

In one embodiment, the suet composition may comprise safflower. In another embodiment, the suet composition may comprise at least about 1% safflower by weight.

In one embodiment, the suet composition may further comprise mineral oil by weight. In another embodiment, the suet composition may further comprise at least about 0.04% mineral oil by weight.

In one embodiment, the suet composition may comprise tallow, peanut meal, peanut pickouts, cracked corn, black oil sunflower seeds, sunflower chips, white millet, and almonds. In another embodiment, the suet composition may comprise at least about 35% tallow, 25% peanut meal, 13% peanut pickouts, 13% cracked corn, 6% black oil sunflower seeds, 5% sunflower chips (e.g., fine sunflower chips), 2% white millet, and 1% almonds by weight. In a further embodiment, the suet composition may further comprise at least about 0.04% mineral oil by weight.

In one embodiment, the suet composition may comprise tallow, peanut meal, peanut pickouts, cracked corn, black oil sunflower seeds, sunflower chips, white millet, and pumpkin seeds. In another embodiment, the suet composition may comprise at least about 35% tallow, 25% peanut meal, 13% peanut pickouts, 13% cracked corn, 6% black oil sunflower seeds, 5% sunflower chips (e.g., fine sunflower chips), 2% white millet, and 1% pumpkin seeds by weight. In a further embodiment, the suet composition may further comprise at least about 0.04% mineral oil by weight.

In one embodiment, the suet composition may comprise tallow, peanut meal, peanut pickouts, cracked corn, dough mix and pecans. In another embodiment, the suet composition may comprise at least about 40% tallow, 8% peanut meal, 2% peanut pickouts, 10% cracked corn, 37% dough mix, and 3% pecans by weight. In a further embodiment, the suet composition may further comprise at least about 0.04% mineral oil by weight.

In one embodiment, the suet composition may comprise tallow, peanut meal, peanut pickouts, cracked corn, dough mix, and red millet. In another embodiment, the suet composition may comprise at least about 40% tallow, 4% peanut meal, 3% peanut pickouts, 10% cracked corn, 37% dough mix, and 6% red millet by weight. In a further embodiment, the suet composition may further comprise at least about 0.04% mineral oil by weight.

In one embodiment, the suet composition may comprise tallow, peanut meal, peanut pickouts, cracked corn, black oil sunflower seeds, sunflower chips, white millet, and safflower. In another embodiment, the suet composition may comprise at least about 35% tallow, 25% peanut meal, 13% peanut pickouts, 13% cracked corn, 6% black oil sunflower seeds, 5% sunflower chips (e.g., fine sunflower chips), 2% white millet, and 1% safflower by weight. In a further embodiment, the suet composition may further comprise at least about 0.04% mineral oil by weight.

In one aspect, the invention provides a container, item, suet holder, suet bird feeder, or package comprising the suet composition described herein.

In another aspect, the invention provides a method of manufacturing a suet composition comprising combining tallow, peanut meal, peanut pickouts, cracked corn, and may further comprise: (a) black oil sunflower seeds and fine sunflower chips; (b) black oil sunflower seeds, fine sunflower chips, and white millet; (c) black oil sunflower seeds, fine sunflower chips, white millet, and almonds; (d) dough mix; (e) dough mix and red millet; (f) dough mix and pecans; (g) black oil sunflower seeds, fine sunflower chips, white millet, and safflower; or (h) black oil sunflower seeds, fine sunflower chips, white millet, and pumpkin seeds. In one embodiment, the method of manufacturing described herein further comprises adding mineral oil to said mixture.

In another aspect, the invention provides a method for attracting desirable birds comprising placing the suet composition described herein at a location where it is available to birds.

In a further aspect, the invention provides a method for increasing sales of a suet composition comprising combining said suet composition components to manufacture a suet composition, wherein said components are selected based on the food preferences or dietary needs of desirable birds in a given region, and identifying said mixture as suitable for birds of a specific region. In one embodiment, the method of increasing sales described herein further comprises labeling said suet composition as formulated for a region. In another embodiment, the method of increasing sales described herein further comprises bagging said suet composition. In another embodiment, the method of increasing sales described herein further comprises offering said suet composition for sale.

In a still further aspect, the invention provides a method of attracting desirable birds comprising combining suet composition components to manufacture a suet composition as described herein, wherein said components are selected based on the food preferences or dietary needs of desirable birds in a region, and making said mixture available to desirable birds.

In another embodiment, the invention provides a system of regional suet compositions comprising at least two mixtures of (a)-(e):
(a) a suet composition corresponding to a first region and comprising tallow, peanut meal, peanut pickouts, cracked corn, black oil sunflower seeds, sunflower chips, white millet, and almonds;
(b) a suet composition corresponding to a second region and comprising tallow, peanut meal, peanut pickouts, cracked corn, black oil sunflower seeds, sunflower chips, white millet, and pumpkin seeds;
(c) a suet composition corresponding to a third region and comprising tallow, peanut meal, peanut pickouts, cracked corn, dough mix and pecans;
(d) a suet composition corresponding to a fourth region and comprising tallow, peanut meal, peanut pickouts, cracked corn, dough mix, and red millet;
(e) a suet composition corresponding to a fifth region and comprising tallow, peanut meal, peanut pickouts, cracked corn, black oil sunflower seeds, sunflower chips, white millet, and safflower.

In one embodiment, the system described herein comprise raisins and white millet. In another embodiment, at least one of said suet compositions comprise safflower. In another embodiment, at least one of said suet compositions further comprise mineral oil. In another embodiment, at least one of said regions are the northeast, southeast, midwest, southwest, or western regions of the United States. In a further embodiment, the system described herein may refer to areas of geographical, climate, terrain, rainfall, temperature, available food sources, degree of development, or flora. In one embodiment, a region may be dry, arid, desert-like environ; a temperate forested region; a prairie-like environ; a mountainous temperature environ; or a humid environ with heavy vegetation.

The foregoing and other objects and aspects of the present invention are explained in greater detail in reference to the description set forth herein.

### BRIEF DESCRIPTION OF THE FIGURES

FIG. 1 depicts the comparison of the mean weight decrease in midwest suet, Morning Song Berry Punch suet, and Morning Song® Year Round suet. The greater decrease in midwest suet compared to Morning Song® Berry Punch suet, and Morning Song® Year Round suet indicates that birds consumed more of the midwest suet as compared to Morning Song® Berry Punch suet, and Morning Song® Year Round suet.

FIG. 2 depicts the comparison of the number of visits by birds attracted by midwest suet, Morning Song® Berry Punch suet, and Morning Song® Year Round suet. The greater increase the number of visits by birds attracted to the midwest suet compared to Morning Song® Berry Punch suet, and Morning Song® Year Round suet indicates that more birds were attracted to the midwest suet as compared to Morning Song® Berry Punch suet, and Morning Song® Year Round suet.

### DETAILED DESCRIPTION OF THE PREFERRED EMBODIMENTS

The invention relates to defined suet compositions for attracting and feeding desirable birds. In particular, the invention relates to a suet composition comprising various amounts of tallow, peanuts (e.g., peanut meal, peanut pickouts), corn (e.g., cracked corn), black oil sunflower, sunflower chips (e.g., fine sunflower chips), white millet, almonds, red millet, dough mix, pecans, pumpkin seeds, and safflower.

### DEFINITIONS

Unless otherwise indicated, all terms used herein have the same meaning as they would to one skilled in the art.

### Regions

Regions of the United States, and other areas of the world, may be defined by an assemblage of contiguous states but may also be defined by climate, geographical boundaries, breeding populations, and food availability. To create a region, general trends in bird distribution may be identified by studying the range maps included in Birds at Your Feeder by Erica H. Dunn and Diane L. Tessaglia-Hymes (W.W. Norton & Company, New York 1999) which summarizes the results of a North American (US and Canada) bird feeding study coordinated by Cornell Lab of Ornithology (“Project FeederWatch.”) Often, trends in bird distribution reflect natural limits to bird occurrence and physical or climate properties that affect bird distribution. For example, the Carolina Chickadee is a bird whose range is clearly limited to the southeastern United States, while the Cactus Wren is a bird whose range is particularly constrained to the southwestern United States. Weather also plays a role in bird distribution as some birds may not be as able as others to tolerate cold, wintry conditions and therefore have a range that is more restricted to southerly latitudes. See Audubon Society website. In addition, other physical attributes of the landscape (e.g., forests of the southeast and northeast, grasslands of the mid-west and Great Plains, the Rocky Mountains, and arid/desert-like habitat) all play a role in further influencing the distribution of birds. These factors may be taken into consideration when describing “regions” that logically separate different assemblages of birds in each particular region.

For example, a region may be dry, arid, desert-like environ similar to the Southwestern region United States; a predominately temperate forested region similar to the Midwest region of the United States; a prairie-like environ; a mountainous temperature environ similar to the Mountain region of the United States; or a humid environ with heavy vegetation similar to the Southeastern region of the United States.

### Desirable Birds

Desirable birds may be songbirds. In addition, other species (e.g., doves, pheasants, quail, woodpeckers) which may not be considered “songbirds” are still considered desirable birds by those who like to feed and watch birds. Additionally, desirable birds may be organized by region by examining bird watching studies, including those conducted by the U.S. Geological Survey (USGS), to first determine desirable birds, and, then to match them to a particular region. See, e.g., Igl, Lawrence D. 1996. Bird Checklists of the United States. Jamestown, N. Dak.: Northern Prairie Wildlife Research Center Online. Exemplary lists of desirable bird species organized by region of the United States are shown in Table 1. This information may be taken into consideration when designating birds as desirable birds and creating different assemblages of desirable birds in each particular region.

TABLE 1
Desirable Bird Species by Exemplary Region of the United States

| Northeast | Midwest | Southeast | West | Southwest |
|---|---|---|---|---|
| Mourning Dove | Ring-necked Pheasant | Mourning Dove | Ring-necked Pheasant | Gambel's Quail |
| Red-bellied Woodpecker | Mourning Dove | Red-bellied Woodpecker | California Quail | Mourning Dove |
| Downy Woodpecker | Red-bellied Woodpecker | Downy Woodpecker | Band-tailed Pigeon | Inca Dove |
| Hairy Woodpecker | Downy Woodpecker | Blue Jay | Mourning Dove | Western Scrub-Jay |
| Blue Jay | Hairy Woodpecker | Carolina Chickadee | Downy Woodpecker | Cactus Wren |
| Black-capped Chickadee | Northern Flicker | Tufted Titmouse | Northern Flicker | Northern Mockingbird |
| Tufted Titmouse | Blue Jay | Carolina Wren | Steller's Jay | Curve-billed Thrasher |
| White-breasted Nuthatch | Black-capped Chickadee | Eastern Bluebird | Western Scrub-Jay | Yellow-rumped Warbler |
| American Tree Sparrow | Tufted Titmouse | American Robin | Black-capped Chickadee | Canyon Towhee |
| Song Sparrow | White-breasted Nuthatch | Northern Mockingbird | Mountain Chickadee | White-crowned Sparrow |
| Dark-eyed Junco | American Robin | Brown Thrasher | Chestnut-backed Chickadee | Dark-eyed Junco |
| Northern Cardinal | American Tree Sparrow | Yellow-rumped Warbler | Oak Titmouse | Pyrrhuloxia |
| House Finch | Field Sparrow | Eastern Towhee | American Robin | House Finch |
| American Goldfinch | Song Sparrow | Chipping Sparrow | Spotted Towhee | Pine Siskin |
| Evening Grosbeak | Dark-eyed Junco | Field Sparrow | California Towhee | Lesser Goldfinch |
| | Northern Cardinal | White-throated Sparrow | White-crowned Sparrow | |
| | Purple Finch | Dark-eyed Junco | Golden-crowned Sparrow | |
| | House Finch | Northern Cardinal | Dark-eyed Junco | |
| | Pine Siskin | Purple Finch | Cassin's Finch | |
| | American Goldfinch | House Finch | House Finch | |
| | Evening Grosbeak | American Goldfinch | Pine Siskin | |
| | | | Lesser Goldfinch | |
| | | | American Goldfinch | |
| | | | Evening Grosbeak | |

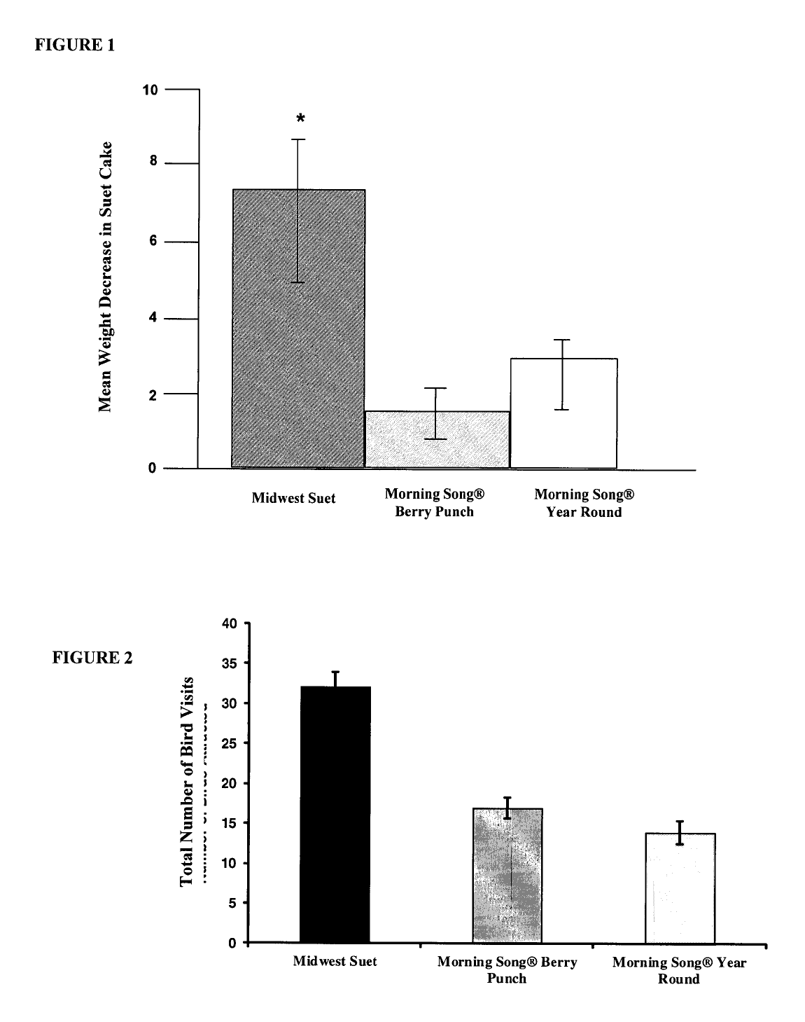

The inventors surprisingly discovered that more of the regional suet compositions described herein may be consumed by birds as compared to other general suet compositions. See FIG. 1. Also, the inventors surprisingly found that the regional suet compositions described herein may attract more birds as compared to other general suet compositions. See FIG. 2. Further, the regional suet compositions described herein may attract more desirable bird species than as compared to other general suet compositions.

### Suet Compositions

The suet composition of the present invention may comprise various amounts of tallow, peanuts (e.g., peanut meal, peanut pickouts), corn (e.g., cracked corn), black oil sunflower, sunflower chips (e.g., fine sunflower chips), white millet, almonds, red millet, dough mix, pecans, pumpkin seeds, and safflower. In one embodiment, the suet composition may comprise various amounts of tallow, peanut meal, peanut pickouts, cracked corn, black oil sunflower, fine sunflower chips, white millet, and almonds. In another embodiment, the suet composition may comprise tallow, peanut meal, peanut pickouts, cracked corn, black oil sunflower, fine sunflower chips, white millet, and pumpkin seeds. In another embodiment, the suet composition may comprise tallow, peanut meal, peanut pickouts, cracked corn, dough mix, and pecans. In a further embodiment, the suet composition may comprise tallow, peanut meal, peanut pickouts, cracked corn, red millet, and dough mix. In a further embodiment, the suet composition may comprise tallow, peanut meal, peanut pickouts, cracked corn, black oil sunflower, fine sunflower chips, white millet, and safflower.

In a further embodiment, the suet composition may comprise various amounts of apples (e.g., in the form of dried apples), artificial color, berry flavoring, BHT (a preservative), biotin, blueberry flavoring, calcium (e.g., in the form of calcium carbonate, calcium iodate, or calcium pantothenate), canary grass seed, cherry flavoring, cholecalciferol (source of vitamin D3), choline chloride, cobalt carbonate, copper oxide, copper sulfate, corn (including but not limited to cracked corn and cornmeal), cranberries, dextrose, DL-methionine, dough mix, ferrous carbonate, ferrous sulfate, finch millet, flax seed, folic acid, gelatin, ground wheat, honey, L-lysine, manganous oxide, menadione sodium bisulfite complex (source of vitamin K activity), milo, mineral oil, mixed tocopherols (a natural preservative), omega-3 fatty acids (e.g., linolenic acid), niacin, oatmeal, pantothenate, pecans, pine nuts, pistachios, pyridoxine hydrochloride, raisins, raspberries, riboflavin, salt, sodium bisulfite complex (source of vitamin K activity), sodium selenite, soy oil, squash seeds, striped sunflower, suet, thiamine, mononitrate, vitamin A, vitamin B12, vitamin D, vitamin E, walnuts, white millet, or zinc oxide. In yet another embodiment, the suet composition may comprise any combination of at least two of the components described herein. In a preferred embodiment, the suet composition may comprise any combination of at least three, four, or five of the components described herein. In another preferred embodiment, the suet composition may comprise any combination of at least six, seven, eight, nine, ten, eleven, twelve, thirteen, fourteen, or fifteen of the components described herein. In another embodiment, the suet composition may consist of any of the foregoing components. In yet another embodiment, the suet composition may consist essentially of any of the foregoing components.

The dough mix may be incorporated to raise the melting point of the composition. In one embodiment, the dough mix may comprise ground corn (e.g., cornmeal) and wheat middlings (wheat mill run). The dough mix may comprise at least about 90% ground corn by weight and at least about 10% wheat middlings. The dough mix may comprise flour and water.

The suet composition may comprise a fat (e.g., lard, tallow, mutton fat). Also, rendered beef fat, vegetable shortening, soybean shortening, or beef suet (beef kidney fat) may be used the fat component of the suet composition.

The suet composition may be shaped into a bell, cake, round cake, square cake, cylinder, pyramid, or ball. The suet composition may be used with any suet cage or feeding apparatus known in the art. See, e.g., SCOTTS Songbird Selections® No-Touch Suet Feeder.

The suet composition may comprise at least one of the components described herein in an amount of at least about 0.01, 0.02, 0.03, 0.04, 0.05, 0.06, 0.07, 0.08, 0.09, or 0.10% by weight. In another embodiment, the suet composition may comprise at least one of the components described herein in an amount of at least about 0.1, 0.2, 0.3, 0.4, 0.5, 0.6, 0.7, 0.8, 0.9, 1, 2, 3, 4, 5, 6, 7, 8, 9, or 10% by weight. In further embodiment, the suet composition may comprise at least one of the components described herein in an amount of at least about 10, 11, 12, 13, 14, 15, 16, 17, 18, 19, or 20% by weight. In yet another embodiment, the suet composition may comprise at least one of the components described herein in an amount of at least about 10, 20, 21, 22, 23, 24, 25, 26, 26, 27, 28, 29, 30, 31, 32, 33, 34, 35, 36, 37, 38, 39, 40, 45, or 50% by weight.

The suet composition may comprise at least one of the components described herein in an amount of at least about 1.0, 1.25, 1.50, 1.75, 2.0, 2.25, 2.50, 2.75, 3.0, 3.25, 3.50, 3.75, 4.0, 4.25, 4.50, 4.75, 5.0, 5.25, 5.50, 5.75, 6.0, 6.25, 6.50, 6.75, 7.0, 7.25, 7.50, 7.75, 8.0, 8.25, 8.50, 8.75, 9.0, 9.25, 9.50, 9.75, or 10% by weight. In another embodiment, the suet composition may comprise at least one of the components described herein in an amount of at least about 10, 10.25, 10.50, 10.75, 11, 11.25, 11.50, 11.75, 12, 12.25, 12.50, 12.75, 13, 13.25, 13.50, 13.75, 14, 14.25, 14.50, 14.75, 15, 15.25, 15.50, 15.75, 16, 16.25, 16.50, 16.75, 17, 17.25, 17.50, 17.75, 18, 18.25, 18.50, 18.75, 19, 19.25, 19.50, 19.75, or 20% by weight. In further embodiment, the suet composition may comprise at least one of the components described herein in an amount of at least about 20, 20.25, 20.50, 20.75, 21, 21.25, 21.50, 21.75, 22, 22.25, 22.50, 22.75, 23, 23.25, 23.50, 23.75, 24, 24.25, 24.50, 24.75, 25, 25.25, 25.50, 25.75, 26, 26.25, 26.50, 26.75, 27, 27.25, 27.50, 27.75, 28, 28.25, 28.50, 28.75, 29, 29.25, 29.50, 29.75, or 30% by weight.

The suet composition may comprise at least one of the components described herein in an amount of at least about 0.01%-0.05%, 0.05%-0.10%, 0.10%-0.50%, 0.50%-1.0%, 1%-5%, or 5%-10% by weight. In another embodiment, the suet composition may comprise at least one of the components described herein in an amount of at least about 10%-30%, 15%-30%, 20%-30%, or 25%-30% by weight.

The suet composition may comprise tallow in an amount of at least about 20%-60%, 25%-50%, 25%-45%, or 35%-40% by weight. In another embodiment, the amount of tallow is at least about 30%-45% by weight. In an exemplary embodiment, the amount of tallow is at least about 30%, 31%, 32%, 33%, 34%, 35%, 37%, 40%, 41%, 42%, 43%, 44%, or 45% by weight.

The suet composition may comprise peanuts in an amount of at least about 1%-40%, 5%-35%, or 6%-30% by weight. In another embodiment, the suet composition comprises peanuts in an amount of at least about 7%-28% by weight. In an exemplary embodiment, the amount of peanuts is at least about 5%, 7%, 10%, 28%, or 30% by weight.

The suet composition may comprise peanut meal in an amount of at least about 2%-60%, 3%-30%, or 3%-30% by weight. In another embodiment, the amount of peanut meal is at least about 4%-25% by weight. In an exemplary embodiment, the amount of peanut meal is at least about 2%, 4%, 8%, or 25% by weight.

The suet composition may comprise peanut pickouts in an amount of at least about 1%-20%, 2%-30%, or 3%-15% by weight. In another embodiment, the amount of peanut pickouts is at least about 2%-13% by weight. In an exemplary embodiment, the amount of peanut pickouts is at least about 2%, 3%, 10%, or 13% by weight. The term “peanut pickouts” as used herein, refers broadly to peanut pieces, and the two terms may be used interchangeably.

The suet composition may comprise cracked corn in an amount of at least about 1%-30%, 5%-30%, or 7%-15% by weight. In another embodiment, the amount of cracked corn is at least about 10%-13% by weight. In an exemplary embodiment, the amount of cracked corn is at least about 5%, 8%, 10%, or 13% by weight.

The suet composition may comprise black oil sunflower seeds in an amount of at least about 1%-50%, 2%-20%, or 1%-10% by weight. In another embodiment, the amount of black oil sunflower seeds is at least about 5%-7% by weight. In an exemplary embodiment, the amount of black oil sunflower seeds is at least about 5%, 5.5%, 6%, or 6.5% by weight.

The suet composition may comprise sunflower chips, optionally fine sunflower chips, in an amount of at least about 1%-20%, 2%-10%, 3%-8%, or 4%-7% by weight. In another embodiment, the suet composition comprises sunflower chips, optionally fine sunflower chips, in an amount of at least about 4.5%-5.5% by weight. In an exemplary embodiment, the amount of sunflower chips, optionally fine sunflower chips, is at least about 4%, 4.9%, 5%, 5.1%, or 5.5% by weight.

The suet composition may comprise white millet in an amount of at least about 1%-10% or 1.5%-3.0% by weight. In another embodiment, the suet composition comprises white millet in an amount of at least about 1.8%-2.5% by weight. In an exemplary embodiment, the amount of white millet is at least about 1.5%, 1.75%, 1.9%, 2.0%, or 2.1% by weight.

The suet composition may comprise almonds in an amount of at least about 0.1%-5.0% by weight. In another embodiment, the suet composition comprises almonds in an amount of at least about 0.8%-1.5% by weight. In an exemplary embodiment, the amount of almonds is at least about 0.8%. 0.9%, 1.0%, or 1.25% by weight.

The suet composition may comprise red millet in an amount of at least about 1%-20%, 2%-10%, or 4%-9% by weight. In another embodiment, the suet composition comprises red millet in an amount of at least about 5%-7% by weight. In an exemplary embodiment, the amount of red millet is at least about 5%, 5.9%, 6.0%, or 6.1% by weight.

The suet composition may comprise dough mix (e.g., wheat middlings and ground corn) in an amount of at least about 1%-50%, 20%-45%, or 30%-45% by weight. In another embodiment, the suet composition comprises dough mix in an amount of at least about 35%-40% by weight. In an exemplary embodiment, the amount of dough mix is at least about 30%, 31%, 32%, 33%, 34%, 35%, 36%, 37%, or 38% by weight.

The suet composition may comprise pecans in an amount of at least about 1%-20%, 1%-10%, or 1%-5% by weight. In another embodiment, the suet composition comprises pecans in an amount of at least about 2%-4% by weight. In an exemplary embodiment, the amount of pecans is at least about 2.8%, 2.9%, 3.0%, or 3.1% by weight.

The suet composition may comprise pumpkin seeds in an amount of at least about 1%, 2%, 3%, 4%, 5%, 6%, 7%, 8%, 9%, or 10% by weight. In another embodiment, the suet composition comprises pumpkin seeds in an amount of at least about 0.75%-1.50% by weight. In an exemplary embodiment, the amount of pumpkin seeds is at least about 1% by weight.

The suet composition may comprise safflower in an amount of at least about 1%, 2%, 3%, 4%, 5%, 6%, 7%, 8%, 9%, or 10% by weight. In another embodiment, the suet composition comprises safflower in an amount of at least about 0.75%-1.50% by weight. In an exemplary embodiment, the amount of safflower is at least about 1% by weight.

The suet composition may comprise mineral oil in an amount of at least about 0.01%, 0.02%, 0.03%, 0.04%, 0.05%, 0.06%, 0.07%, 0.08%, 0.09% or 1% by weight. In another embodiment, the suet composition comprises mineral oil in an amount of at least about 0.03%-0.05% by weight. In an exemplary embodiment, the amount of mineral oil is at least about 0.04% by weight.

The suet composition may comprise tallow in an amount of at least about 30-45% by weight, peanut meal in an amount of at least about 3-30% by weight, peanut pickouts in an amount of at least about 2-15% by weight, cracked corn in an amount of at least about 8-15% by weight. The suet composition may comprise black oil sunflower seeds in an amount of at least about 4%-9% by weight, and sunflower chips in an amount of at least about 3%-10% by weight. The suet composition may comprise black oil sunflower seeds in an amount of least about 4%-9% by weight, sunflower chips in an amount of at least about 3%-10% by weight, white millet in an amount of at least about 1%-3% by weight, and almonds in an amount of at least about 0.5%-1.5% by weight. The suet composition may comprise black oil sunflower seeds in an amount of least about 4%-9% by weight, sunflower chips in an amount of at least about 3%-10% by weight, white millet in an amount of at least about 1%-3% by weight, and pumpkins seeds in an amount of at least about 0.5%-1.5% by weight. The suet composition may comprise black oil sunflower seeds in an amount of least about 4%-9% by weight, sunflower chips in an amount of at least about 3%-10% by weight, white millet in an amount of at least about 1%-3% by weight, and safflower in an amount of at least about 0.5%-1.5% by weight. The suet composition may comprise dough mix in an amount of least about 35%-40% by weight and pecans in an amount of at least about 1%-5% by weight. The suet composition may comprise dough mix in an amount of least about 35%-40% by weight and red millet in an amount of at least about 5%-10% by weight. The suet composition may still further comprise mineral oil in an amount of at least about 0.03%-0.05% by weight.

The suet composition may comprise tallow in an amount of at least about 30%, 35%, 40%, or 45% by weight, peanut meal in an amount of at least about 4%, 8%, 20%, or 25% by weight, peanut pickouts in an amount of at least about 2%, 3%, 10%, or 13% by weight, cracked corn in an amount of at least about 8%, 10%, 13%, or 15% by weight. The suet composition may comprise black oil sunflower seeds in an amount of at least about 4%, 5%, 6%, 7%, or 9% by weight, sunflower chips in an amount of at least about 3%, 4%, 5%, or 6% by weight, and white millet in an amount of at least about 1%, 2%, or 3% by weight. The suet composition may comprise black oil sunflower seeds in an amount of at least about 4%, 5%, 6%, 7%, or 9% by weight, sunflower chips in an amount of at least about 3%, 4%, 5%, or 6% by weight, white millet in an amount of at least about 1%, 2%, or 3% by weight, and almonds in an amount of at least about 0.5%, 1%, or 1.5% by weight. The suet composition may comprise black oil sunflower seeds in an amount of at least about 4%, 5%, 6%, 7%, or 9% by weight, sunflower chips in an amount of at least about 3%, 4%, 5%, or 6% by weight, white millet in an amount of at least about 1%, 2%, or 3% by weight, and pumpkin seeds in an amount of at least about 0.5%, 1%, or 1.5% by weight. The suet composition may comprise black oil sunflower seeds in an amount of at least about 4%, 5%, 6%, 7%, or 9% by weight, sunflower chips in an amount of at least about 3%, 4%, 5%, or 6% by weight, white millet in an amount of at least about 1%, 2%, or 3% by weight, and safflower in an amount of at least about 0.5%, 1%, or 1.5% by weight. The suet composition may comprise dough mix in an amount of at least 35%, 36%, 37%, or 38% by weight and pecans in an amount of at least about 1%, 2%, 3%, 4%, or 5% by weight. The suet composition may comprise dough mix in an amount of at least 35%, 36%, 37%, or 38% by weight and red millet in an amount of at least about 4%, 5%, 6%, 7%, or 8% by weight. The suet composition may still comprise mineral oil in an amount of at least about 0.03%, 0.04%, or 0.05% by weight.

The suet composition may comprise artificial color, BHT (a preservative), biotin, calcium (e.g., in the form of calcium carbonate, calcium iodate, or calcium pantothenate), canary grass seed, cherry flavor, cholecalciferol (source of vitamin D3), choline chloride, cobalt carbonate, copper oxide, copper sulfate, corn (including but not limited to cracked corn), cranberries, dextrose, DL-methionine, dough mix, ferrous carbonate, ferrous sulfate, finch millet, flax seed, folic acid, gelatin, ground wheat, honey, L-lysine, manganous oxide, menadione sodium bisulfite complex (source of vitamin K activity), milo, mineral oil, mixed tocopherols (a natural preservative), omega-3 fatty acids (e.g., linolenic acid), niacin, pantothenate, pecans, pinenuts, pistachios, pyridoxine hydrochloride, raspberries, riboflavin, salt, sodium bisulfite complex (source of vitamin K activity), sodium selenite, soy oil, striped sunflower, thiamine, mononitrate, vitamin A, vitamin B 12, vitamin D, vitamin E, walnuts, or zinc oxide in an amount of at least about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, or 25% by weight, 0.01%-10% by weight, or 1%-25% by weight.

The suet composition may comprise tallow in an amount of at least about 30%-45% by weight, peanuts (e.g., peanut meal, peanut pickouts) in an amount of at least about 5%-30% by weight, cracked corn in an amount of at least about 5%-15% by weight, and comprise:
(a) black oil sunflower seeds in an amount of at least about 3%-10% by weight, sunflower chips in an amount of at least about 3%-10% by weight, and white millet in an amount of at least about 0.5-3% by weight;
(b) black oil sunflower seeds in an amount of at least about 3%-10% by weight, sunflower chips in an amount of at least about 3%-10% by weight, white millet in an amount of at least about 0.5-3% by weight, and almonds in an amount of at least about 0.5%-2% by weight;
(c) black oil sunflower seeds in an amount of at least about 3%-10% by weight, sunflower chips in an amount of at least about 3%-10% by weight, and white millet in an amount of at least about 0.5-3% by weight, and pumpkin seeds in an amount of at least about 0.5%-2% by weight;
(d) black oil sunflower seeds in an amount of at least about 3%-10% by weight, sunflower chips in an amount of at least about 3%-10% by weight, and white millet in an amount of at least about 0.5-3% by weight, and safflower in an amount of at least about 0.5%-2% by weight;
(e) dough mix in an amount of at least about 35%-45% by weight;
(f) dough mix in an amount of at least about 35%-45% by weight and pecans in an amount of at least about 1%-5% by weight; or
(g) dough mix in an amount of at least about 35%-45% by weight and red millet in an amount of at least about 3%-10% by weight.

The suet composition may still further comprise mineral oil in an amount of at least about 0.01%-0.06% by weight.

The suet composition may comprise tallow in an amount of at least about 30%-45% by weight, peanut meal in an amount of at least about 3%-30% by weight, peanut pickouts in an amount of at least about 1%-20% by weight, cracked corn in an amount of at least about 5%-15% by weight, and further comprise:
(a) black oil sunflower seeds in an amount of at least about 3%-10% by weight, sunflower chips in an amount of at least about 3%-10% by weight, and white millet in an amount of at least about 0.5-3% by weight;
(b) black oil sunflower seeds in an amount of at least about 3%-10% by weight, sunflower chips in an amount of at least about 3%-10% by weight, white millet in an amount of at least about 0.5-3% by weight, and almonds in an amount of at least about 0.5%-2% by weight;
(c) black oil sunflower seeds in an amount of at least about 3%-10% by weight, sunflower chips in an amount of at least about 3%-10% by weight, and white millet in an amount of at least about 0.5-3% by weight, and pumpkin seeds in an amount of at least about 0.5%-2% by weight;
(d) black oil sunflower seeds in an amount of at least about 3%-10% by weight, sunflower chips in an amount of at least about 3%-10% by weight, and white millet in an amount of at least about 0.5-3% by weight, and safflower in an amount of at least about 0.5%-2% by weight;
(e) dough mix in an amount of at least about 35%-45% by weight;
(f) dough mix in an amount of at least about 35%-45% by weight and pecans in an amount of at least about 1%-5% by weight; or
(g) dough mix in an amount of at least about 35%-45% by weight and red millet in an amount of at least about 3%-10% by weight.

The suet composition may still further comprise mineral oil in an amount of at least about 0.01%-0.06% by weight.

The suet composition may comprise tallow in an amount of at least about 30%, 35%, 40%, or 45% by weight, peanuts in an amount of at least about 5%, 7%, 8%, 10%, 25%, or 28% by weight, and cracked corn in an amount of at least about 10%, 13%, 15%, or 20% by weight and may further comprise
(a) black oil sunflower seeds in an amount of at least about 5%, 6%, or 7% by weight, sunflower chips in an amount of at least about 4%, 5%, or 6% by weight, and white millet in an amount of at least about 1%, 2%, or 3% by weight;
(b) black oil sunflower seeds in an amount of at least about 5%, 6%, or 7% by weight, sunflower chips in an amount of at least about 4%, 5%, or 6% by weight, and white millet in an amount of at least about 1%, 2%, or 3% by weight, and almonds in an amount of at least about 0.5%, 1%, or 2% by weight;
(c) black oil sunflower seeds in an amount of at least about 5%, 6%, or 7% by weight, sunflower chips in an amount of at least about 4%, 5%, or 6% by weight, and white millet in an amount of at least about 1%, 2%, or 3% by weight, and pumpkin seeds in an amount of at least about 0.5%, 1%, or 2% by weight;
(d) black oil sunflower seeds in an amount of at least about 5%, 6%, or 7% by weight, sunflower chips in an amount of at least about 4%, 5%, or 6% by weight, and white millet in an amount of at least about 1%, 2%, or 3% by weight, and safflower in an amount of at least about 0.5%, 1%, or 2% by weight;
(e) dough mix in an amount of at least about 36%, 37%, or 38% by weight;
(f) dough mix in an amount of at least about 36%, 37%, or 38% by weight and pecans in an amount of at least about 2%, 3%, or 4% by weight; or
(g) dough mix in an amount of at least about 36%, 37%, or 38% by weight and red millet in an amount of at least about 4%, 5%, 6%, or 7% by weight.

The suet composition may still further comprise mineral oil in an amount of at least about 0.03%, 0.04%, 0.05%, 0.06% by weight.

The suet composition may comprise tallow in an amount of at least about 30%, 35%, 40%, or 45% by weight, peanut meal in an amount of at least about 3%, 4%, 8%, 10%, 25%, or 28% by weight, peanut pickouts in an amount of at least about 1%, 2%, 3%, 10%, 13%, or 15% by weight, and cracked corn in an amount of at least about 10%, 13%, 15%, or 20% by weight and may further comprise
(a) black oil sunflower seeds in an amount of at least about 5%, 6%, or 7% by weight, sunflower chips in an amount of at least about 4%, 5%, or 6% by weight, and white millet in an amount of at least about 1%, 2%, or 3% by weight;
(b) black oil sunflower seeds in an amount of at least about 5%, 6%, or 7% by weight, sunflower chips in an amount of at least about 4%, 5%, or 6% by weight, and white millet in an amount of at least about 1%, 2%, or 3% by weight, and almonds in an amount of at least about 0.5%, 1%, or 2% by weight;
(c) black oil sunflower seeds in an amount of at least about 5%, 6%, or 7% by weight, sunflower chips in an amount of at least about 4%, 5%, or 6% by weight, and white millet in an amount of at least about 1%, 2%, or 3% by weight, and pumpkin seeds in an amount of at least about 0.5%, 1%, or 2% by weight;
(d) black oil sunflower seeds in an amount of at least about 5%, 6%, or 7% by weight, sunflower chips in an amount of at least about 4%, 5%, or 6% by weight, and white millet in an amount of at least about 1%, 2%, or 3% by weight, and safflower in an amount of at least about 0.5%, 1%, or 2% by weight;
(e) dough mix in an amount of at least about 36%, 37%, or 38% by weight;
(f) dough mix in an amount of at least about 36%, 37%, or 38% by weight and pecans in an amount of at least about 2%, 3%, or 4% by weight; or
(g) dough mix in an amount of at least about 36%, 37%, or 38% by weight and red millet in an amount of at least about 4%, 5%, 6%, or 7% by weight.

The suet composition may still further comprise mineral oil in an amount of at least about 0.03%, 0.04%, 0.05%, 0.06% by weight.

The suet composition may comprise at least about 86% tallow, peanut meal, and peanut pickouts, and cracked corn by weight. The suet composition may comprise at least about 57% tallow, peanut meal, and peanut pickouts, and cracked corn by weight. The suet composition may comprise at least about 60% tallow, peanut meal, and peanut pickouts, and cracked corn by weight. In one embodiment, the balance of the weight of any given suet composition may be brought to 100% by adding black oil sunflower seeds, sunflower chips, white millet, almonds, red millet, dough mix, pecans, pumpkin seeds, or safflower.

The suet composition of the invention may be placed in a container, item, suet holder, suet bird feeder, bag, or package. For example, the suet composition may be packaged for commercial availability. Further, the container of suet composition may be identified as adapted for a particular region, attractive to an assemblage of desirable birds, or adapted to be attractive to an assemblage of desirable birds in a particular region. For example, the container of suet composition may be labeled, including labeled as adapted for a particular region, attractive to an assemblage of desirable birds, or adapted to be attractive to an assemblage of desirable birds in a particular region. The suet compositions described herein may be marketed including advertised as adapted for a particular region, attractive to an assemblage of desirable birds, or adapted to be attractive to an assemblage of desirable birds in a particular region.

### Methods

The suet composition of the invention may be produced by a method comprising combining the components described herein in the amounts set forth herein. The invention also provides for a method of feeding birds comprising supplying the suet composition of the invention. The invention also provides for methods of attracting desirable birds, including but not limited to songbirds, comprising placing the suet composition as described herein at a location, optionally in a suet holder or suet bird feeder, where said desirable birds can find and consume said suet composition.

The invention provides a method for marketing a suet composition comprising combining components to manufacture a suet composition, wherein said suet composition comprises components that were selected based on the food preferences or dietary needs of desirable birds in a given region.

The invention provides for a method of attracting desirable birds comprising making a suet composition available to desirable birds, optionally in a suet holder or suet bird feeder, wherein said suet composition comprises components that were selected based on the food preferences or dietary needs of desirable birds in a given region. The invention also provides for a method of attracting desirable birds in a geographic region comprising making a suet composition available to desirable birds, optionally in a suet holder or suet bird feeder, wherein said suet composition comprises components that were selected based on the food preferences or dietary needs of desirable birds in said region.

The invention also provides for method for increasing sales of a suet composition comprising combining components to make a suet composition, wherein said suet composition comprises components that were selected based on the food preferences or dietary needs of desirable birds in a given region.

Another embodiment of the invention is a method for formulating a suet composition to attract desirable birds in a region comprising combining components to make a suet composition, wherein said suet composition comprises components that were selected based on the food preferences or dietary needs of desirable birds in a given region.

The methods described herein may further comprise offering for sale said suet composition in said region. The methods described herein may also comprise labeling a suet composition as adapted to said region. The invention may also comprise bagging, boxing, or wrapping a suet composition or offering a suet composition for sale, wherein said suet composition comprises components that were selected based on the food preferences or dietary needs of desirable birds in a given region. In another embodiment, the components are selected to attract desirable birds of a particular region. In a further embodiment, the regions may be the northeast, southeast, midwest, west, or southwest regions of the United States.

### Systems

The invention also provides a system of regional suet compositions comprising at least one, two, three, four, five, six, seven, eight, nine, or ten suet compositions. The individual suet compositions described herein may correspond to a given region, wherein said region may be defined by geography, breeding populations of birds, political boundaries (e.g., an assemblage of states), prevailing climate conditions (e.g., microclimates, USDA plant hardiness zones), physical barriers to distribution (e.g., a region circumscribed by mountains, deserts, rivers, lakes), development (e.g., suburbs), or availability of food items. In one embodiment, the system may comprise (a) a first suet composition corresponding to a first region, (b) a second suet composition corresponding to a second region, (c) a third suet composition corresponding to a third region, (d) a fourth suet composition corresponding to a fourth region, and (e) a fifth suet composition corresponding to a fifth region. In another embodiment, the system may comprise (a) a first suet composition corresponding to a first geographic region, (b) a second suet composition corresponding to a second geographic region, (c) a third suet composition corresponding to a third geographic region, (d) a fourth suet composition corresponding to a fourth geographic region, and (e) a fifth suet composition corresponding to a fifth geographic region. In another embodiment, the system may comprise (a) a first suet composition corresponding to a first climate region, (b) a second suet composition corresponding to a second climate region, (c) a third suet composition corresponding to a third climate region, (d) a fourth suet composition corresponding to a fourth climate region, and (e) a fifth suet composition corresponding to a fifth climate region. In further embodiment, the system may comprise (a) a first suet composition corresponding to a first region defined by breeding/wintering populations of desirable birds, (b) a second suet composition corresponding to a second region defined by breeding/wintering populations of desirable birds, (c) a third suet composition corresponding to a third region defined by breeding/wintering populations of desirable birds, (d) a fourth suet composition corresponding to a fourth region defined by breeding/wintering populations of desirable birds, and (e) a fifth suet composition corresponding to a fifth region defined by breeding/wintering populations of desirable birds.

In one embodiment, the system may comprise (a) a first suet composition corresponding to a first geographic region and comprising tallow, peanut meal, peanut pickouts, cracked corn, black oil sunflower seeds, sunflower chips, white millet, and almonds; (b) a second suet composition corresponding to a second geographic region and comprising tallow, peanut meal, peanut pickouts, cracked corn, black oil sunflower seeds, sunflower chips, white millet, and pumpkin seeds; (c) a third suet composition corresponding to a third geographic region and comprising tallow, peanut meal, peanut pickouts, cracked corn, black oil sunflower seeds, sunflower chips, white millet, and safflower; (d) a fourth suet composition corresponding to a fourth geographic region and comprising tallow, peanut meal, peanut pickouts, cracked corn, dough mix, and pecans; and (e) a fifth suet composition corresponding to a fifth geographic region and comprising tallow, peanut meal, peanut pickouts, cracked corn, dough mix and red millet.

Further embodiments of the present invention will now be described with reference to the following examples. The examples contained herein are offered by way of illustration and not by any way of limitation.

### EXAMPLES

### Example 1

### Selection of the Bird Food Mixtures

The components and amounts of each of the bird food mixtures described in U.S. patent application Ser. No. 13/250,433 were developed by first determining the five most desirable bird species in each of five regions (e.g., northeast, southeast, midwest, western, and southwest.) Each of the bird food mixtures was then designed to match the preferred foods of those five assemblages of bird species. See Birds at Your Feeder by Erica H. Dunn and Diane L. Tessaglia-Hymes (W.W. Norton & Company, New York 1999); The Birds of North America series published by the Academy of Natural Sciences (Philadelphia, Pa.) and the American Ornithologists' Union (Washington, D.C.) for dietary needs. These regional bird food mixtures were the basis for the development of the regional suet compositions described herein. Five exemplary regional suet compositions are described in Table 2.

TABLE 2
Regional Blends

| Western | | Northeastern | | Southeastern | | Southwestern | | Midwestern | |
|---|---|---|---|---|---|---|---|---|---|
| Ingredient | % | Ingredient | % | Ingredient | % | Ingredient | % | Ingredient | % |
| Tallow | 35 | Tallow | 35 | Tallow | 40 | Tallow | 40 | Tallow | 35 |
| Peanut meal | 25 | Peanut meal | 25 | Peanut meal | 8 | Peanut meal | 4 | Peanut meal | 25 |
| Peanut pickouts | 13 | Peanut pickouts | 13 | Peanut pickouts | 2 | Peanut pickouts | 3 | Peanut pickouts | 13 |
| Cracked corn | 13 | Cracked corn | 13 | Cracked corn | 10 | Cracked corn | 10 | Cracked corn | 13 |
| Mineral oil | 0.04 | Mineral oil | 0.04 | Mineral oil | 0.04 | Mineral oil | 0.04 | Mineral oil | 0.04 |
| Black oil | 6 | Black oil | 6 | Dough mix | 37 | Red millet | 6 | Black oil | 6 |
| sunflower seeds | | sunflower seeds | | | | | | sunflower seeds | |
| Sunflower chips | 5 | Sunflower chips | 5 | Pecans | 3 | Dough mix | 37 | Sunflower Chips | 5 |
| White millet | 2 | White millet | 2 | | | | | White Millet | 2 |
| Almonds | 1 | Pumpkin seeds | 1 | | | | | Safflower | 1 |
| Total (approx.) | 100 | Total (approx.) | 100 | Total (approx.) | 100 | Total (approx.) | 100 | Total (approx.) | 100 |

### Example 2

### Study Protocol for Comparing Regional Suet Compositions to Other Suet Compositions for Amount of Suet Consumed

Suet compositions may be tested for the amount of consumption (e.g., amount of suet consumed by birds) against other suet compositions. For example, a regional suet composition (e.g., Northeast, Southeast, Midwest, West, and Southwest described herein) may be compared against a commercially available suet composition, such as Morning Song® Year-Round Suet comprises rendered beef suet, red milo, cracked corn, black oil sunflower, and white millet; Morning Song® Berry Punch Suet comprises rendered beef suet, white millet, cracked corn, red millet, and blueberry flavoring; or KAYTEE® Suet & Seed comprises rendered beef suet, white millet, corn, and black oil sunflower.

Each study may be conducted for a minimum of 9 days using the Northeast, Midwest, West, Southeast, or Southwest suet compositions and another commercially available suet composition (e.g., Morning Song® Year-Round Suet, Morning Song® Berry Punch Suet, or KAYTEE® Suet & Seed). These may be “blind studies” where the observers do not know the name brand or composition of the suet compositions being tested.

### Station Set-Up and Feeder Type

### Station Set-Up

A station may be constructed for attracting, feeding, and observing birds outdoors using three different suet compositions at a time to compare their ability to attract different birds, the number of birds attracted, or the amount of suet consumed. Each Station may be divided into three 3 feeders placed in a line with about 10 feet between each feeder. The feeders were placed in a line that the observer could face during data collection periods. SCOTTS® Songbird Selections® No Touch Suet baskets may be used as feeders. An effort should be made to place the feeders equal distances from cover (i.e., trees, shrubs, and other obstructions.) Feeders may be placed at an angle so that one could observe birds feeding on both sides of the feeder. Woodland edges or riparian habitats are preferred sites for suet stations.

### Observations

### Amount of Suet Consumed

On each day that Surveys are conducted, suet blocks may be weighed and then placed in the field in the morning and left for a minimum for six hours. The suet should be brought in every night to avoid disturbances by nocturnal mammals. At the time suet blocks are taken down they should be weighed. Feeders should not be placed outside during periods of weather that could potentially damage the suet blocks or change the weight significantly (e.g., heavy rain or snow). If precipitation occurs when the suet blocks are outside, they should be allowed to dry overnight before their weights are recorded. Initial photos of the suet blocks should be taken as well as at the end of every run. A run may consist of 3 days of observation, one hour at each site per day. If observations cannot take place due to weather or other circumstances the observations will be delayed until the next available day. The suet blocks should be rotated between the three feeders so that a different suet composition is at each feeder each day. Data may be collected for a minimum of 3 days per run, 9 days total. Unfavorable weather may extend this time period of the entire test.

Suet compositions may be tested for their ability to attract desirable birds, attract birds (e.g., number of visits), or consumption (e.g., amount of suet consumed by birds) against other suet compositions. For example, a regional suet composition (e.g., Northeast, Southeast, Midwest, West, and Southwest described herein) may be compared against a commercially available suet composition, such as Morning Song® Year-Round Suet comprises rendered beef suet, red milo, cracked corn, black oil sunflower, and white millet; Morning Song® Berry Punch Suet comprises rendered beef suet, white millet, cracked corn, red millet, and blueberry flavoring; or KAYTEE® Suet & Seed comprises rendered beef suet, white millet, corn, and black oil sunflower.

Each study may be conducted for a minimum of 9 days using the Northeast, Midwest, West, Southeast, and Southwest.

### Example 3

### Study Protocol for Comparing Regional Suet Compositions to Other Suet Compositions for Number and/or Type of Birds Attracted

Different suet compositions may be tested for their ability to attract desirable birds or the number of birds. For example, a regional suet composition (e.g., Northeast, Southeast, Midwest, West, and Southwest described herein) may be compared against a commercially available suet composition, such as Morning Song® Year-Round Suet (comprising rendered beef suet, red milo, cracked corn, black oil sunflower, and white millet); Morning Song® Berry Punch Suet (comprising rendered beef suet, white millet, cracked corn, red millet, and blueberry flavoring); or KAYTEE® Suet & Seed (comprising rendered beef suet, white millet, corn, and black oil sunflower) may be tested for their ability to attract desirable birds or the number of birds.

Each study may be conducted for a minimum of 9 days using the Northeast, Midwest, Western, Southeast, or Southwest suet compositions and another commercially available suet composition (e.g., Morning Song® Year-Round Suet, Morning Song® Berry Punch Suet, or KAYTEE® Suet & Seed). These may be “blind studies” where the observers do not know the name brand or composition of the suet compositions being tested.

### Station Set-Up and Feeder Type

### Station Set-Up

A station may be constructed for attracting, feeding, and observing birds outdoors using three different suet compositions at a time to compare their ability to attract different birds, the number of birds attracted, or the amount of suet consumed. Each Station may be divided into three 3 feeders placed in a line with about 10 feet between each feeder. The feeders may be placed in a line that the observer could face during data collection periods. SCOTTS® Songbird Selections® No Touch Suet baskets may be used as feeders. An effort should be made to place the feeders equal distances from cover (i.e., trees, shrubs, and other obstructions.) Feeders may be placed at an angle so that one could observe birds feeding on both sides of the feeder. Woodland edges or riparian habitats are preferred sites for suet stations.

### Suet

On each day that Surveys are conducted, suet blocks may be weighed and then placed in the field in the morning and left for a minimum for six hours. The suet should be brought in every night to avoid disturbances by nocturnal mammals. At the time suet blocks are taken down they may be weighed. Feeders should not be placed outside during periods of weather that could potentially damage the suet blocks or change the weight significantly (e.g., heavy rain or snow). If precipitation occurs when the suet blocks are outside, they should be allowed to dry overnight before their weights are recorded. Initial photos of the suet blocks should be taken as well as at the end of every run. A run may consist of 3 days of observation, one hour at each site per day. If observations cannot take place due to weather or other circumstances the observations will be delayed until the next available day. The suet blocks should be rotated between the three feeders so that a different suet composition is at each feeder each day. Data may be collected for a minimum of 9 days. Unfavorable weather may extend this time period of the entire test.

### Observations—Bird Count Method: (Frequency, Timing, Details)

There will be one hour long observation for each of the 3 days of each run. All bird species that visit the feeders will be counted during the observation period. Birds are only counted when they are on the feeder or perched on top of the feeder. Birds perched on shepherd's hangers or on the ground are not counted.

Surveys may be conducted between the times of 30 minutes after sunrise and 30 minutes before sunset with an effort to schedule survey times that coincide with periods of frequent bird feeding. Participants may conduct the surveys at the same time during the day for every day of the Survey with a one hour grace period. Specific weather conditions during each field watch may be noted by the study participants. On occasion, surveys may be carried out during periods of light precipitation, however, they may be postponed during times of heavy precipitation during which birds do not frequent feeders.

After arriving at the Station, the observer should allow a short period of time before the Survey began, approximately 5 minutes, to allow the birds to resume normal feeding behavior before beginning with data collection. However, even if there are no birds on the feeders after approximately 5 minutes the Survey may be conducted.

All bird observations were documented including: the location, date, and type of bird (species) visiting a particular feeder.

### Example 4

### Comparison of Midwestern Suet Composition to Morning Song® Berry Punch Suet and Morning Song®Year Round Suet for Amount of Suet Consumed

Studies were conducted following the protocol described in Example 2 and a suet composition named “Midwestern Suet” comprising tallow, peanut meal, peanut pickouts, cracked corn, black oil sunflowers, sunflower chips, white millet, and safflower to test how much of the suet was consumed compared to other commercially available suet. Surprisingly, the inventor discovered that birds consumed more of the Midwestern suet composition as compared to Morning Song® Berry Punch Suet and Morning Song® Year Round Suet.

In FIG. 1, the amount of Midwestern suet consumed by birds as compared to Morning Song® Berry Punch Suet and Morning Song® Year Round Suet. The amount of consumption was calculated as a decrease in the suet weight between the beginning and the end of the run. Therefore, the inventor surprisingly found that more of the Midwestern suet composition was consumed by birds as compared to Morning Song® Berry Punch Suet and Morning Song® Year Round Suet.

### Example 5

### Comparison of Midwestern Suet Composition to Morning Song® Berry Punch Suet and Morning Song® Year Round Suet for Number of Birds Attracted

Studies were conducted following the protocol described in Example 3 and a suet composition named “Midwestern Suet” comprising tallow, peanut meal, peanut pickouts, cracked corn, black oil sunflowers, sunflower chips, white millet, and safflower to test how many birds were attracted to the Midwestern Bird Blend suet compared to other commercially available suet. In FIG. 2, the number of total number of bird visits, which is indicative of the total number of birds attracted, by the Midwest suet was compared to Morning Song® Berry Punch Suet and Morning Song® Year Round Suet. Surprisingly, the inventor discovered that more birds were attracted to the Midwestern suet composition as compared to Morning Song® Berry Punch Suet and Morning Song® Year Round Suet.

Species that may be attracted by the Midwestern Suet includes Mourning Dove, Red-bellied woodpecker, Downy Woodpecker, Hairy Woodpecker, Carolina Wren, Chickadee, Titmouse, White-breasted Nuthatches, Blue Jay, European Starling, House Sparrow, Purple Finch, House Finch, American Goldfinch, Am. Tree Sparrow, Chipping Sparrow, Song Sparrow, White-throated Sparrow, Dark-eyed Junco, Northern Cardinal, Indigo Bunting, Red-winged Blackbird, Common Grackle, Brown-headed Cowbird.

Although the invention has been described in some detail by way of illustration and example for purposes of clarity of understanding, it were obvious that certain changes and modifications may be practiced within the scope of the appended claims. Modifications of the above-described modes for carrying out the invention that are obvious to persons of skill in animal physiology, ornithology, zoology, and/or related fields are intended to be within the scope of the following claims.

All publications (e.g., Non-Patent Literature), patents, patent application publications, and patent applications mentioned in this specification are indicative of the level of skill of those skilled in the art to which this invention pertains. All such publications (e.g., Non-Patent Literature), patents, patent application publications, and patent applications are herein incorporated by reference to the same extent as if each individual publication, patent, patent application publication, or patent application was specifically and individually indicated to be incorporated by reference.

1. A composition comprising tallow, peanut meal, peanut pickouts, cracked corn, and further comprising:
(a) black oil sunflower seeds, sunflower chips, and white millet,
(b) black oil sunflower seeds, sunflower chips, white millet, and almonds,
(c) black oil sunflower seeds, sunflower chips, white millet, and pumpkin seeds,
(d) black oil sunflower seeds, sunflower chips, white millet, and safflower,
(e) dough mix,
(f) dough mix and red millet, or
(g) dough mix and pecans.

2. The composition of claim 1, wherein said composition comprises at least about 30%-45% tallow by weight.

3. (canceled)

4. The composition of claim 1, wherein said composition comprises at least about 3%-30% peanut meal by weight.

5. (canceled)

6. The composition of claim 1, wherein said composition comprises at least about 1%-15% peanut pickouts by weight.

7. (canceled)

8. The composition of claim 1, wherein said composition comprises at least about 5%-15% cracked corn by weight.

9. (canceled)

10. The composition of claim 1, wherein said composition comprises at least about 4%-8% black oil sunflower seeds by weight.

11. (canceled)

12. The composition of claim 1, wherein said composition comprises at least about 1%-7% sunflower chips by weight.

13. (canceled)

14. The composition of claim 1, wherein said composition comprises at least about 0.5%-5% white millet by weight.

15. (canceled)

16. The composition of claim 1, wherein said composition comprises at least about 0.5%-5% almonds by weight.

17. (canceled)

18. The composition of claim 1, wherein said composition comprises at least about 0.5%-5% pumpkin seeds by weight.

19. (canceled)

20. The composition of claim 1, wherein said composition comprises at least about 0.5%-5% safflower by weight.

21. (canceled)

22. The composition of claim 1, wherein said composition comprises at least about 30%-45% dough mix by weight.

23. (canceled)

24. The composition of claim 1, wherein said composition comprises at least about 1%-5% pecans by weight.

25. (canceled)

26. The composition of claim 1, wherein said composition comprises at least about 3%-8% red millet by weight.

27. (canceled)

28. (canceled)

29. (canceled)

30. (canceled)

31. The composition of claim 1, wherein said composition comprises at least about 6% black oil sunflower seeds, 5% sunflower chips, and 2% white millet by weight.

32. (canceled)

33. The composition of claim 1, wherein said composition comprises at least about 6% black oil sunflower seeds, 5% sunflower chips, 2% white millet, and 1% almonds by weight.

34. (canceled)

35. The composition of claim 1, wherein said composition comprises at least about 6% black oil sunflower seeds, 5% sunflower chips, 2% white millet, and 1% pumpkin seeds by weight.

36. (canceled)

37. The composition of claim 1, wherein said composition comprises at least about 6% black oil sunflower seeds, 5% sunflower chips, 2% white millet, and 1% safflower by weight.

38. (canceled)

39. (canceled)

40. (canceled)

41. The composition of claim 1, wherein said composition comprises at least about 37% dough mix by weight and 6% red millet by weight.

42. (canceled)

43. The composition of claim 1, wherein said composition comprises at least about 37% dough mix by weight and 3% pecans by weight.

44-51. (canceled)

52. A method of attracting desirable birds comprising combining components of the composition of claim 1 to manufacture a suet composition, wherein said components are selected based on the food preferences of desirable birds in a region, and making said composition available to desirable birds.

53-55. (canceled)

56. A system of suet compositions comprising at least two mixtures of (a)-(e):
(a) a first suet composition comprising tallow, peanut meal, peanut pickouts, cracked corn, black oil sunflower seeds, white millet, and almonds;
(b) a second suet composition comprising tallow, peanut meal, peanut pickouts, cracked corn, black oil sunflower seeds, white millet, and pumpkin seeds;
(c) a third suet composition comprising tallow, peanut meal, peanut pickouts, cracked corn, black oil sunflower seeds, white millet, and safflower;
(d) a fourth suet composition comprising tallow, peanut meal, peanut pickouts, cracked corn, dough mix, and pecans; and
(e) a fifth suet composition comprising tallow, peanut meal, peanut pickouts, cracked corn, dough mix, and red millet.

57-108. (canceled)
